(19) United States
(12) Patent Application Publication
(10) Pub. No.: US 2024/0079703 A1
(43) Pub. Date: Mar. 7, 2024

(54) BATTERY MODULE, MODULAR BATTERY SYSTEM AND METHOD OF ASSEMBLING MODULAR BATTERY SYSTEM

(71) Applicant: VARTA Microbattery GmbH, Elwangen Jagst (DE)

(72) Inventors: Matthias Geiss, Unterschneidheim-Zipplingen (DE); Rainer Hahn, Jagstzell (DE); Dieter Kloos, Fichtenau (DE); Roman Stübler, Lauchheim (DE)

(21) Appl. No.: 18/272,376

(22) PCT Filed: Dec. 16, 2021
(86) PCT No.: PCT/EP2021/086172

§ 371 Date: Jul. 14, 2023

(30) Foreign Application Priority Data
Jan. 15, 2021 (EP) 21151815.4

(51) Int. Cl. H01M 50/258; H01M 50/213; H01M 50/227; H01M 50/296; H01M 50/574

(52) U.S. Cl. CPC H01M 50/258; H01M 50/213; H01M 50/227; H01M 50/296; H01M 50/574

(57) ABSTRACT

A battery module includes a module housing; and at least two battery blocks arranged within the module housing, wherein the battery blocks each include at least two energy storage elements having at least one positive electrode and at least one negative electrode, the at least two energy storage elements of one battery block are connected in series and/or in parallel; each of the battery blocks provides a maximum of 60 volts DC; the module housing has at least two positive power connection contacts and at least two negative power connection contacts connected to the battery blocks so that the DC voltages supplied by the battery blocks can be tapped from outside the module housing; and a maximum DC voltage that can be tapped between a positive and a negative power connection contact is 60 volts.

### TECHNICAL FIELD

This disclosure relates to a battery module having a module housing in which at least two battery blocks are arranged. The battery module is particularly suitable for the construction of a high-voltage battery system. Furthermore, this disclosure relates to a modular battery system, in particular a modular high-voltage battery system, and a method of assembling such a modular battery system.

### BACKGROUND

Battery modules are rechargeable electrical energy storage devices that can be used, for example, in automotive applications or stationary energy storage systems. In a battery module, usually several energy storage cells are connected be able to provide the currents and voltages required for the respective application. It is also possible to combine the individual energy storage cells within the battery module into two or more battery blocks.

For example, WO 2017/063858 A1 describes a cell module for storing electrical energy, in which two or more cells, each with at least one positive and at least one negative electrode, are arranged in the interior of a module housing. The module housing has at least three external electrical connection poles.

In comparatively large battery modules intended for storing energy, for example, in the KWh range, a large number of energy storage cells are connected in series and/or in parallel. For vehicle batteries and energy storage systems with a high energy content, it is expedient to connect individual battery modules into so-called “high-voltage stacks” to form a modular battery system. At higher voltages, the cable cross sections can be dimensioned smaller. Furthermore, downstream power electronics can usually operate more efficiently with a high-voltage system. For example, a DC/DC converter connected upstream of an inverter may become superfluous. Overall, therefore, high-voltage battery systems in large power ranges bring various technical and economic advantages.

A well-known problem with battery modules and modular battery systems, especially in the high-voltage range, is the danger posed by unintentional contacting of opposite poles of the systems. In general, a contact voltage≥60 V DC is considered critical so the range below 60 V DC is defined as the low-voltage range and the range above 60 V DC is defined as the high-voltage range. In the high-voltage range, special measures must generally be provided to ensure protection against contact. In particular, special insulation and protective measures must be provided in the high-voltage range for the handling and use of corresponding elements. In the high-voltage range, parts of a battery module or battery system must be permanently protected against contact. This also applies to storage and transport as well as during and also after use, i.e., also during disposal. In addition, recycling is made more difficult by potentially high-voltage, aged battery modules in the high-voltage range. High-voltage systems therefore involve greater technical effort. The resulting more complex installation of such battery modules or battery systems is accompanied by increased costs and the installer must work with special protective equipment.

It could therefore be helpful to provide a battery module and a modular battery system in which no voltages dangerous to the touch occur in the non-installed state and which are nevertheless readily suitable for use in high-voltage systems, among other things and battery modules suitable for use in the low-voltage range.

### SUMMARY

We provide a battery module including a module housing; and at least two battery blocks arranged within the module housing, wherein the battery blocks each include at least two energy storage elements having at least one positive electrode and at least one negative electrode, the at least two energy storage elements of one battery block are connected in series and/or in parallel; each of the battery blocks provides a maximum of 60 volts DC; the module housing has at least two positive power connection contacts and at least two negative power connection contacts connected to the battery blocks so that the DC voltages supplied by the battery blocks can be tapped from outside the module housing; and a maximum DC voltage that can be tapped between a positive and a negative power connection contact is 60 volts.

We also provide a modular battery system including at least two battery modules including a module housing; and at least two battery blocks arranged within the module housing, wherein the battery blocks each include at least two energy storage elements having at least one positive electrode and at least one negative electrode, the at least two energy storage elements of one battery block are connected in series and/or in parallel; each of the battery blocks provides a maximum of 60 volts DC; the module housing has at least two positive power connection contacts and at least two negative power connection contacts connected to the battery blocks so that the DC voltages supplied by the battery blocks can be tapped from outside the module housing; and a maximum DC voltage that can be tapped between a positive and a negative power connection contact is 60 volts; and at least two battery blocks of one of the battery modules and/or at least two battery blocks from different battery modules of the battery system are electrically connected via the positive and negative electrical power connection contacts of their module housings.

We further provide a method of assembling a battery system including providing at least two battery modules including a module housing; and at least two battery blocks arranged within the module housing, wherein the battery blocks each include at least two energy storage elements having at least one positive electrode and at least one negative electrode, the at least two energy storage elements of one battery block are connected in series and/or in parallel; each of the battery blocks provides a maximum of 60 volts DC; the module housing has at least two positive power connection contacts and at least two negative power connection contacts connected to the battery blocks so that the DC voltages supplied by the battery blocks can be tapped from outside the module housing; and a maximum DC voltage that can be tapped between a positive and a negative power connection contact is 60 volts; assembling the battery modules to form a battery system; and electrically connecting the battery blocks of individual battery modules to each other.

### BRIEF DESCRIPTION OF THE DRAWINGS

FIG. 1 schematically shows an illustration of a battery module with two battery blocks.

FIG. 2 schematically shows a further illustration of a battery module.

FIG. 3 schematically shows a representation of a possible wiring of the power connection contacts of the battery module in the example according to FIG. 2.

FIG. 4 schematically shows a further illustration of a battery module.

FIG. 5 schematically shows a depiction of a possible wiring of the power connection contacts of the battery module in the example according to FIG. 4.

FIG. 6 schematically shows a display of a design option of the power connection contacts of the battery module in an example according to FIG. 4.

FIG. 7 schematically shows a depiction of the structure of a modular battery system.

FIG. 8 schematically shows a depiction of the structure of a modular battery system with safety line.

FIGS. 9A, 9B and 9C schematically show comparison of the structure of our modular battery systems (FIGS. 9B and 9C) with a conventional modular battery system (FIG. 9A).

### DETAILED DESCRIPTION

Our battery module is characterized by:
a. the battery module has a module housing;
b. at least two battery blocks are arranged within the module housing;
c. the battery blocks each comprise at least one, preferably at least two, energy storage elements each having at least one positive electrode and at least one negative electrode; and
d. the at least two energy storage elements of a battery block are connected in series and/or in parallel.

In particular, the battery module is characterized by e. to g.:
e. each of the battery blocks provides a maximum of 60 volts DC;
f. the module housing has at least two positive power connection contacts and at least two negative power connection contacts connected to the battery blocks so that the DC voltages supplied by the battery blocks can be tapped from outside the module housing; and
g. the maximum DC voltage that can be tapped between a positive and a negative power connection contact is 60 volts.

The concept is that ideally no voltages>60 V occur within the module housing and, in particular, no voltages>60 V can be tapped by connecting only two power connection contacts. This is achieved by limiting the maximum voltage of the battery blocks. Thus, no voltage≥60 V can be tapped via two connection contacts assigned to a single battery block.

Examples according to which two or more of the battery blocks are electrically connected within the module housing, wherein a common positive and a common negative power connection contact is connected to the connected battery blocks, are likewise encompassed by this disclosure. Since the DC voltage which can be tapped between the common positive and the common negative power connection contact must not exceed 60 volts, care must be taken to ensure that the connection of the battery blocks does not result in such a voltage being applied to the power connection contacts, for example, by suitable selection of the number or the nominal voltages of the individual battery blocks. For example, if the individual battery blocks each supply a voltage of 18 V, no more than three of these blocks should be connected in series. As a result, no voltage dangerous to the touch can occur at the power connection contacts accessible from the outside.

However, it is very well possible to provide voltages>60 V by external electrical connection of the power connection contacts if the battery blocks have corresponding power ratings. Accidental simultaneous contacting of more than two power connection contacts is virtually impossible so that the battery module is very safe to handle.

In its simplest form, the battery module has exactly one positive and one negative power connection contact for each battery block. In this example, a battery module with two battery blocks would therefore have a total of four external power connection contacts, two for each block.

The battery blocks are preferably connected by electrical conductors within the module housing to their associated power connection contacts.

It is particularly preferred that the battery blocks encompassed by the battery module, when connected in series, provide a total voltage≥60 V. However, such a connection is possible exclusively by an electrical connection of the power connection contacts of the battery module.

Our battery module offers the possibility of flexible connection of its battery blocks. It can be installed individually or in combination with other battery modules, in particular other of our battery modules, both in low-voltage systems and in high-voltage systems. In this context, the battery module combines safety-related advantages since no voltages dangerous to the touch can emanate from the battery module before it is installed. Nevertheless, the battery module can be used to generate high battery voltages in individual battery modules or also overall in a modular battery system, whereby such high battery voltages are often very advantageous for economic-technical reasons, as explained above.

Our battery block is characterized by comprising a plurality of energy storage elements electrically connected to achieve the maximum voltage of 60 volts DC. The energy storage elements are electrically and possibly also spatially separated from the energy storage elements of another battery block. An electrical connection can only be formed via the power connection contacts. Preferably, the electrically connected energy storage elements of one battery block are electrically isolated from energy storage elements of another battery block. This can be achieved in particular by spatial decoupling, which implements an air gap, for example, and/or by an insulating material, for example a plastic plate or the like.

Preferably, the battery blocks each comprise a holder for the energy storage elements they enclose. In some configuration, they may also comprise their own housing enclosing the energy storage elements. Preferably, each battery block has a positive output terminal and a negative output terminal, and the energy storage elements it comprises can be accessed exclusively through these output terminals.

Preferably, the battery blocks are spatially spaced from each other within the housing. Additionally or alternatively, the battery blocks can be electrically insulated from each other. For this purpose, if necessary, additional devices can be provided to insulate the individual battery blocks within the housing such as the insulating material already mentioned.

It is possible for two or, if necessary, more battery blocks to be implemented within a common holder for all energy storage cells by electrically connecting the energy storage cells of a block accordingly. In this example, two or more battery blocks are thus provided within one spatial unit.

Preferably, however, each battery block forms a unit. Particularly preferably, each battery block has its own holder for the energy storage elements of the respective battery block. Preferably, the individual battery blocks are spatially separated from one another within the housing of the battery module so that electrical insulation of the battery blocks from one another is realized in a particularly simple manner within the battery module.

Each electrochemical energy storage element comprises at least one electrochemical cell capable of storing electrical energy, preferably exactly one electrochemical cell capable of storing electrical energy. In multiple cells, these may be connected in series and/or in parallel. Preferably, the energy storage elements used in a battery module each comprise their own housing, for example, a foil housing or a metallic housing, in which the at least one electrochemical cell is arranged.

Electrochemical energy storage cells always comprise at least one positive and at least one negative electrode separated from each other by a separator. During operation of electrochemical cells, an electrochemical, energy-supplying reaction takes place which is composed of two electrically coupled but spatially separated partial reactions. One partial reaction, which takes place at a comparatively lower redox potential, occurs at the negative electrode, and one at a comparatively higher redox potential occurs at the positive electrode. During discharge, electrons are released at the negative electrode by an oxidation process, resulting in an electron flow via an external consumer to the positive electrode, from which a corresponding quantity of electrons is taken up. A reduction process thus takes place at the positive electrode. At the same time, an ion current corresponding to the electrode reaction occurs within the electrochemical cell for the purpose of charge equalization. This ion current passes through the separator and is usually provided by a liquid electrolyte.

In secondary (rechargeable) electrochemical energy storage cells, which are used in a particularly preferred manner, this discharge reaction is reversible, i.e., it is possible to reverse the conversion of chemical energy to electrical energy that occurs during discharge.

Within the battery blocks of the battery module, the individual energy storage elements can in principle be connected in any way depending on the respective requirements, i.e., in particular in series and/or in parallel, but always under the condition that the maximum voltages mentioned above are not exceeded by the connection.

In an installation of the battery module or, if applicable, the installation of a modular battery system using battery modules, the power connection contacts can be connected so that the desired voltages can be made available, for example, in the low-voltage range, but also with particular advantage in the high-voltage range.

The battery module offers considerable advantages in the production, provision, transport and installation of the battery module or, if applicable, a modular battery system using the battery modules, since no critical touch voltages can occur before the final installation. Therefore, no elaborate measures such as special protective equipment and other precautions, are required for the installer to work under high voltage. Furthermore, no technical measures are required that usually have to be provided for contact protection in high-voltage systems. On the one hand, this makes it much easier and safer to work with regard to the installation of the battery modules or the corresponding modular battery systems. On the other hand, considerable costs can be saved by dispensing with technical high-voltage protection measures.

The power connection contacts can be implemented in particular by metallic components. The power connection contacts can be designed, for example, as pole bolts to which the electrical conductors leading to the respective battery blocks are welded, soldered or electrically coupled in some other way. If the module housing comprises metallic components, it may be necessary to provide appropriate pole bushings to electrically insulate the power connection contacts from the housing. Such technical measures are known and require no further explanation.

During installation, the power connection contacts of the battery modules can be connected in different ways. For example, the battery blocks of a battery module can thus be connected in series and/or in parallel. In particular, however, it is also possible to electrically connect the power connection contacts of one battery module to the power connection contacts of another battery module, whereby it is possible to connect battery blocks belonging to different battery modules in series and/or in parallel. The battery module can therefore be used very flexibly and can, to a certain extent, be used as a universal module for a wide variety of applications in the low-voltage range and in the high-voltage range.

Overall, there are numerous possibilities for the wiring of the power connection contacts. For low-voltage applications, for example, parallel configurations are often of interest when connecting the power connection contacts, whereby an increase in capacitance is achieved. For high-voltage applications, serial configurations in the connection of the power connection contacts are often of interest, increasing the voltage. Combinations of serial and parallel connections can also be advantageous. Furthermore, connections with external sources or other battery systems, also independently, are possible.

Particularly preferably, the battery module is characterized by at least one of:
a. the module housing is preferably prismatic;
b. the electrical power connection contacts of the module housing are located on at least two sides of the module housing, in particular on opposite sides of the module housing; and
c. for each battery block, the module housing has a positive and a negative electrical power connection contact, one of which is located on one of the sides and the other on another of the sides of the module housing, in particular on opposite sides of the module housing.

Preferably, a. and b., and in some configurations also a., b. and c., are realized in combination with each other.

The prismatic design of the module housing is particularly advantageous because it allows a battery module to be provided that can be used very flexibly. The prismatic shape is very favorable in terms of space utilization and can be used with particular advantage, for example, in a stacked arrangement of several battery modules. In addition, prismatic shapes, in particular cubic or cuboidal shapes, are already widely used in battery modules so that the battery module is compatible with conventional battery modules in terms of geometrical conditions.

Particularly in stacked arrangements of the battery modules, the arrangement of the electrical power connection contacts of the module housing on different, in particular opposite sides of the module housing is very advantageous, since this makes the connection of different power connection contacts of the different battery modules very simple and practical. In this context, two principal design options are particularly advantageous.

In a first example, the module housing comprises a side on which all negative power connection contacts are arranged and another side, preferably an opposite side of the module housing, on which all positive power connection contacts are arranged.

In another example, the module housing comprises a side on which a part of the negative power connection contacts and a part of the positive power connection contacts are arranged. On a further side, preferably an opposite side of the module housing, all further positive power connection contacts and all further negative power connection contacts are arranged. It can preferably be provided that the positive and the negative power connection contacts are arranged on the respective sides in alternating sequence. In particular, regular sequences forming a pattern may be preferred. However, other possible arrangements of the positive and negative power connection contacts on the respective sides are also possible, for example, all positive or all negative power connection contacts of this side can be combined in a specific area of the respective side and the respective other power connection contacts can be combined in another specific area.

Depending on which side of the module housing the positive or negative power connection contacts are located, the orientation of the respective battery block or array of battery blocks inside the module housing with which these power connection contacts are associated may be oriented accordingly. For example, in the example in which all of the negative power connection contacts are located on one side and all of the positive power connection contacts are located on an opposite side of the module housing, the respective battery blocks or arrays of battery blocks may be arranged with parallel polarity adjacent to each other within the battery housing. In the example in which the respective sides, in particular the opposite sides of the battery module, are provided with both positive and negative power connection contacts, it may be expediently provided that the individual battery blocks or assemblies of battery blocks with which the respective power connection contacts are associated are arranged in anti-parallel polarity side by side. These configurations have the particular advantage that the paths between the respective poles of the battery blocks or the assemblies of battery blocks to the power connection contacts on the outside of the module housing are short, which results in advantages in the production and in the material consumption and the robustness of the battery modules.

The example of the battery module, in which all positive power connection contacts are located on one side of the battery module and all negative power connection contacts are located on another side, preferably the opposite side, is particularly suitable for parallel connection of the battery blocks or assemblies of battery blocks. In this example, the battery blocks or groups of battery blocks located within a battery module can be connected in parallel with each other, or the battery blocks or groups of battery blocks of different battery modules can be connected in parallel with each other, whereby combinations are also possible.

With this configuration, in which all positive power connection contacts are located on one side of the battery module and all negative power connection contacts are located on another, preferably the opposite side, a serial connection is also possible, whereby the connection technology may be somewhat more complex in this example.

The example of the battery module in which the positive and the negative power connection contacts are located, as it were, mixed on the preferably opposite sides of the module housing, is particularly suitable for serial connection of the battery blocks or the groups of battery blocks. In this example, both the battery blocks or groups of battery blocks within a battery module and the battery blocks or groups of battery blocks from different battery modules can be connected in series during installation.

Such connections of the positive and negative electrical power connection contacts of the battery modules are particularly advantageous in stacking of the battery modules, which are preferably cuboid-shaped for these applications since the paths for the connections are very short here so that the connection technology is simple and practicable.

The electrical power connection contacts can, for example, be designed as a male or female part of a connector. For example, all negative power connection contacts may be male and all positive power connection contacts may be female. In another example, all power connection contacts on one side of the module housing may be male and all power connection contacts on one side of the module housing may be female.

In a particularly preferred example of the battery module, the battery module is characterized by:

a. the electrical power connection contacts on one side of the module housing are designed as a male part and the electrical power connection contacts on the other side, in particular on the opposite side, of the module housing are designed as a female part of a plug connection.

This design further simplifies the connection technique for the installer.

Of course, it is also possible to make all power connection contacts female and to connect the power connection contacts of adjacent battery modules by double male connectors. Conversely, it is also possible to make all power connection contacts male and to connect the power connection contacts of adjacent battery modules to each other using double female connectors.

The design of the power connection contacts can be carried out independently of whether there are exclusively positive or exclusively negative power connection contacts or both positive and negative power connection contacts on the respective side of the module housing. By appropriately designing the respective power connection contacts in a corresponding distribution on the sides of the module housing, it is thus possible to provide very easily connectable battery modules for stacking arrangements, which can be connected in a simple manner for connection without the need for complex connections of individual contacts.

The module housing itself can be formed from various materials. For example, plastic is suitable for this purpose due to its insulating properties and low weight and ease of processing. In other examples, metallic housings can be provided, for example, made of cast aluminum, or edge-bent housings made of corresponding sheet metal. Furthermore, combinations of materials, so-called hybrid housings are also possible. Metal housings may be preferred in some circumstances since metallic housings have heat dissipating properties. Cooling can be realized, for example, by the intermediation of heat-conducting materials whose cooling effect is dissipated to the housing.

As mentioned above, in module housings made of metal, it is usually necessary to electrically insulate at least the electrically conductive components of the power connection contacts from the module housing.

In a particularly preferred example of the battery module, the battery module is characterized by at least one of:
a. the energy storage elements of a battery pack are cylindrical round cells; and
b. the energy storage elements of a battery block are held by a holder, in particular a holder made of plastic.

Preferably, a. and b. are realized in combination with each other.

Cylindrical round cells generally have a circular base. Compared to button cells, which also have a circular base, cylindrical round cells are characterized by that their height is generally greater than their diameter. Cylindrical round cells are particularly suitable as energy storage elements for the battery blocks of the battery module since on the one hand they are capable of providing the required voltages. On the other hand, their shape offers the advantage of particularly practicable cooling when they are combined to form battery blocks since cavities are inevitably created between the individual cylindrical round cells, which are favorable for cooling or generally for temperature exchange. In other examples, it may also be envisaged that prismatically shaped energy storage elements are used for the battery blocks. Depending on the particular requirements, further provisions may be made for cooling the energy storage elements, if necessary.

Within a battery block, the energy storage elements are preferably arranged in several parallel rows. In cylindrical round cells, these are aligned parallel along their longitudinal axes. For example, 12 rows of 14 cylindrical round cells arranged next to each other can be combined and framed, for example, by a holder made of plastic.

The fixture may have appropriate electrical conductors and contacts to implement a desired electrical connection of the individual energy storage elements within the cell block.

Within the cell block, the energy storage cells and, in particular, the round cells can form a regular pattern in one or, if necessary, several planes, with the energy storage cells and, in particular, round cells preferably being arranged at the smallest possible distance from one another.

Particularly preferably, each cell block has a positive and a negative electrical connection pole, which can preferably also be part of the holder. For the electrical connection of the battery blocks, these connection poles can be connected to the corresponding power connection contacts.

The energy storage elements are preferably lithium ion cells. The electrodes of lithium-ion cells are known to be able to take up and release lithium ions reversibly.

In general, it is preferred that energy storage elements are used in each of the individual battery blocks that all have the same structure. In principle, however, it is also possible for different energy storage elements to be used within the battery blocks.

The battery module can comprise, for example, two battery blocks, each of which provides a DC voltage of approx. 50 V. Each battery block comprises a plurality of energy storage elements, in particular cylindrical lithium-ion round cells. For example, cylindrical round cells with a cut-off voltage of 4.2 V per individual cell can be used. These cylindrical round cells may be arranged, for example, in rows of 14 round cells each, with 12 such rows being provided, for example. The energy storage elements within this battery block are then connected such that a maximum DC voltage of approximately 50 V is achieved, for example.

Particularly preferably, the battery module is characterized by:
a. the module housing has at least one further connection contact for coupling at least one communication line and/or at least one safety line.

Such a further connection contact on the module housing offers various advantages. In particular, data transmission which is required, for example, in connection with a battery management system, can be carried out via this or possibly several further connection contacts on the module housing. In particular, in a connection of several battery modules, data transmission between the battery modules and also with higher-level devices may be necessary and useful. The further connection contact or contacts can therefore be designed as data connectors, for example.

Alternatively or in addition to a data transmission channel, the at least one further connection contact can be used to provide a safety line. By such a safety line, which is looped through all battery modules of a battery system and/or through all battery blocks of a battery module, the system can be interrupted in the event of a fault. This provides an additional redundant safety function so that the system can be shut down in the event of a fault. However, if a fault is detected in a battery block or a battery module, it can also be initially provided that the problem is solved communicatively via the software and that the system is only switched off via the safety line if the problem persists.

Preferably, a battery management system is connected to each battery block of the battery module, and preferably also with each individual energy storage element of the battery blocks, and in some preferred examples, a separate battery management system is connected to each battery block. Battery management systems are generally used to control and/or regulate the regular operation of the battery blocks and the energy storage elements. For this purpose, the battery modules and/or, if applicable, the individual battery blocks and/or the energy storage elements of the battery module can be equipped with electronic and/or sensory components that enable detection of various parameters (battery state of charge, temperature, cell voltages, cell currents and others) and, if applicable, data processing and/or data forwarding. By monitoring such parameters, the safe operation of the battery module can be ensured, for example, by switching off in the event of overvoltage and undervoltage, in the event of overtemperature or undertemperature, or by equalizing the state of charge of individual energy storage cells in the respective battery block of the battery module.

The battery management system can be combined in a particularly advantageous manner with the safety line explained above, whereby preferably each battery module or each battery block can interrupt the safety line via its respective battery management system.

Furthermore, the battery module can be used in connection with a multilevel converter device. This is based on the fact that battery modules of the type described or systems consisting of such battery modules generally act as a direct current source. With the aid of a multilevel converter, such systems can also be connected to an AC grid. In such converters, the voltages of individual battery modules or, in general, individual units of the system are added in a time-delayed manner for different periods of time. If the voltages of the individual units are sufficiently small in relation to their total voltage, sinusoidal voltage characteristics, for example, can be generated to a good approximation.

Typically, a multilevel inverter technology is supported by a plurality of battery modules. In the battery modules, however, the multilevel inverter technology can be integrated directly into a module housing of a battery module to operate the individual battery blocks within the battery module according to the multilevel inverter technology. This makes this technology economically applicable also in smaller power ranges, for example, in connection with a so-called fully integrated AC battery for multiple applications on-grid and off-grid or, for example, as a “reserve tank” for electrically powered vehicles.

We further provide a modular battery system, in particular a modular high-voltage battery system, characterized by:
a. the battery system is constructed from at least two battery modules as described above; and
b. at least two battery blocks of one of the battery modules and/or at least two battery blocks from different battery modules are electrically connected via the positive and negative electrical power connection contacts of the module housings.

As already explained in connection with the battery modules, combining several battery modules to form a battery system allows a large number of possible connections. Battery blocks of a battery module can be connected via the power connection contacts, whereby voltages>60 volts can also be formed. Above all, however, it is possible to connect battery blocks from two or more different battery modules. Both serial and parallel connections as well as combinations of parallel and serial connections can be realized. Thus, battery systems can be provided for low-voltage ranges as well as for high-voltage ranges.

The individual battery modules of the battery system can be used very flexibly as building blocks to achieve the provision of electrical voltages for different fields of application. For example, a system with 48 V can be provided as a voltage standard. Likewise, it is possible to realize a modular battery system in the high-voltage range without the risk of contact-hazardous voltages during production, provision, transport and assembly before the battery system is finally activated.

Particularly preferably, the modular battery system is characterized by:
a. the battery modules of the battery system are stacked; and
b. within the stack, sides of the module housings of adjacent battery modules on which negative and/or positive power connection contacts are arranged face each other.

For stacking the battery modules, it is useful if the battery module housings have sides that are parallel to each other. Preferably, therefore, the module housings are prismatic and have, for example, a cuboid shape. When stacking the battery modules, it can be provided that spacers are provided between individual battery modules so that free spaces are formed between the housings of the battery modules, which can be advantageous, for example, with regard to cooling. Furthermore, such spacings can also be advantageous with regard to the connection technology between the power connection contacts of the individual battery modules.

Preferably, adjacent battery modules within the stack or their battery blocks are electrically connected via the negative and/or positive power connection contacts on the sides facing each other.

In a particular way, the modular battery system is characterized by:
a. within the stack, the power terminal contacts of adjacent battery modules are in direct contact with each other, and preferably the power terminal contacts are directly or indirectly electrically connected.

The electrical contact between the individual power connection contacts can be realized, for example, by plug-in connections using female and male contacts or generally using female and male connection contacts. Likewise, other plug-in connectors or other direct or direct connector contacts are also possible. By appropriate design of the contacts, connection of the individual battery blocks or groups of battery blocks within a module housing of a battery module and/or connection of battery blocks or groups of battery blocks located in different and in particular in adjacent battery modules can be realized.

In this regard, in a first preferred example, the modular battery system may have at least one of:
a. the battery modules each comprise a first side on which all negative power connection contacts are arranged and a second side on which all positive power connection contacts are arranged;
b. within the stack, the battery modules are arranged such that, in adjacent battery modules, the first side of one of the adjacent battery modules faces the second side of the other of the adjacent battery modules; and
c. at least a part of the battery blocks of the respective battery modules are connected in parallel.

Preferably, a. and b., and particularly preferably a., b. and c., are realized in combination with each other. With regard to further details on this example of the battery system or the battery modules, reference is also made to the above description.

In a further preferred example of the modular battery system, the battery system is characterized by at least one of:
a. the battery modules each have a first side on which a part of the negative power terminal contacts and a part of the positive power terminal contacts are disposed, and a second side on which all other positive power terminal contacts and all other negative power terminal contacts are disposed;
b. within the stack, the battery modules are arranged such that, in adjacent battery modules, the first side of one of the adjacent battery modules faces the second side of the other of the adjacent battery modules; and
c. the battery blocks of the respective battery modules are at least partially connected in series with battery blocks of a respective adjacent battery module and/or with battery blocks of the same battery module.

The above-mentioned a. and b. are preferably implemented together with one another. A combination of the aforementioned a., b. and c. is particularly preferred. With regard to further details on this example of the battery system or the battery modules, reference is also made to the above description.

In a very particularly preferred example of the modular battery system, the battery system is characterized by:
a. the battery system has at least one switch for activating and/or deactivating the connection of the battery blocks of the battery modules forming the battery system.

By a switch that activates and/or deactivates the connection of the battery blocks or the connections of battery blocks of the battery modules forming the battery system, a further safety level is realized which reliably avoids the possible occurrence of critical contact voltages during assembly of the battery system up to a final step of activation. The switch for activation and/or deactivation can in principle be designed in any way, for example, in the form of an additional relay or another plug, for example, a so-called service plug, which closes a final bridge during the switching of the battery blocks. In particular, the battery modules may also have manually operable switches that activate and/or deactivate the connection. The design of the battery system with such a switch is particularly advantageously suitable for high-voltage battery systems.

Further preferably, the system is set up for multilevel inverter technology. In this context, the multilevel inverter technology can be implemented with respect to the entire system with the plurality of modules or, if necessary, also at the level of the individual modules with a corresponding control of the individual battery blocks, as already explained above. Reference is therefore also made to the above description with respect to further details.

We further provide a method of assembling a battery system, in particular a high-voltage battery system, comprising:
a. at least two battery modules as described above are provided;
b. the battery modules are assembled to form a battery system; and
c. the battery blocks of the individual battery modules are connected to each other.

The advantages of this assembly method result from the fact that no critical contact voltages occur with the individual battery modules of the system, as explained above. The resulting advantages in terms of safety, in particular of the installer or assembler, and the resulting advantages due to the possible elimination of safety-related measures have already been explained above so that reference is also made to this in connection with the method.

In a particularly preferred and advantageous example, the process is characterized by the following:
a. a final activation of the connection of the battery blocks takes place by actuating at least one switch of the battery system, wherein the at least one switch is provided to activate and/or deactivate the connection of the battery blocks of the battery modules forming the battery system.

Processes are known with which a battery system for the high-voltage range can be constructed from individual battery modules. For example, battery modules are used which each supply a voltage of 50 V (low-voltage modules). By stacking eight such battery modules and connecting them in series, a high voltage of 400 V can be provided. Since the voltage of the individual battery modules is too low for a critical touch voltage to occur, handling individual modules is not dangerous. However, as soon as two modules are connected in series, there is a danger. Accordingly, this problem is addressed by activating the at least one switch.

Our battery modules have the advantage that the individual battery modules can be used both as low-voltage modules and as high-voltage modules. This universal applicability of the same battery module is economically very interesting since fewer variants are required to cover customer requirements. The individual battery modules can be handled safely before their installation as low-voltage modules, especially with regard to manufacturing, installation and also recycling. In addition, a particular advantage of the battery modules is that only a small number of battery modules are required to build a high-voltage battery system. The battery modules offer a high degree of flexibility and configurability for various applications. For example, parallel and/or series connected battery blocks or arrays of battery blocks within a battery module are possible and externally configurable by the installer.

It is even possible for individual battery blocks or arrays of cell blocks within a single battery module to be operated independently of each other. This can be used, for example, for redundantly designed backup systems. The battery modules can also be used for small systems, for example, low-voltage systems. In general, the system with the battery modules combines the advantages of a conventional stacked battery system, but the disadvantages of a conventional system are largely eliminated.

Further features and advantages result from the following description of examples in connection with the drawings. The individual features can be realized individually or in combination with each other.

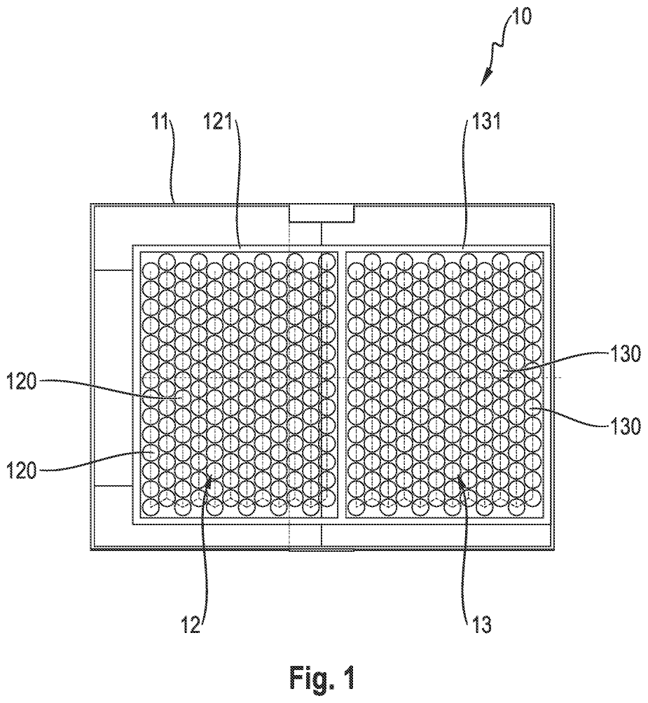

FIG. 1 shows a cross-section through an example of a battery module 10. Two battery blocks 12 and 13 are arranged within a cuboid module housing 11. Both battery blocks each comprise a plurality of individual energy storage elements 120 and 130, respectively. In this example, the energy storage elements 120, 130 are cylindrical round cells based on lithium-ion. Fourteen round cells 120 or 130 are arranged in a row in each example, with a battery block comprising a total of twelve such rows. The cylindrical round cells 120, 130 are arranged parallel to each other in a regular pattern in a space-saving manner. This arrangement is each held by a cell holder 121 and 131 respectively, these cell holders 121, 131 providing a framing of the cylindrical round cells 120, 130. Expediently, the cell holders 121, 131 are made of a plastic material so that they simultaneously effect an insulation of the two cell blocks 12 and 13 from each other. The individual energy storage elements 120, 130 are connected in parallel and/or series within the respective cell blocks 12 and 13. However, the two cell blocks 12 and 13 themselves are not connected. The respective positive terminals 12a and 13a and negative terminals 12b and 13b of the cell blocks 12 and 13 are routed to the power connection contacts 125, 126, 135 and 136 via separate electrical conductors. Cell blocks 12 and 13 each supply a DC voltage of 60 V. Thus, no voltage dangerous to the touch can be tapped simply by accidentally touching two of the four power connection contacts at the same time.

However, if the power connection contacts 125 and 136 are connected by a suitable electrical conductor (serial connection), a voltage of 120 V, which is dangerous to touch, can be tapped at the power connection contacts 126 and 135. The same applies in an electrical connection of the power connection contacts 126 and 135, as a result of which a voltage of 120 V can be tapped at the power connection contacts 125 and 136.

Each of the cell blocks 12, 13 may have its own battery management system, not shown in detail here.

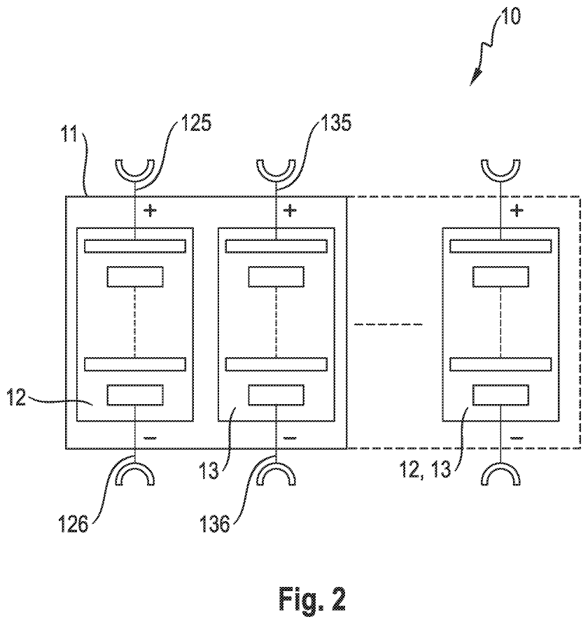

FIG. 2 illustrates a variant of a battery module 10, in which two battery blocks 12 and 13 or possibly further cell blocks are arranged within the module housing 11. The further cell blocks are indicated by the dashed portion of the module housing. Further shown are the positive power connection contacts 125 and 135 and the negative power connection contacts 126 and 136 of the battery blocks 12 and 13, respectively, which in this example are located on opposite sides of the module housing 11. Thus, the cell blocks 12 and 13 can in principle be connected in any desired manner. They can be connected with each other or with battery blocks of other battery modules, or they can be connected with external sources, if necessary also independently of each other.

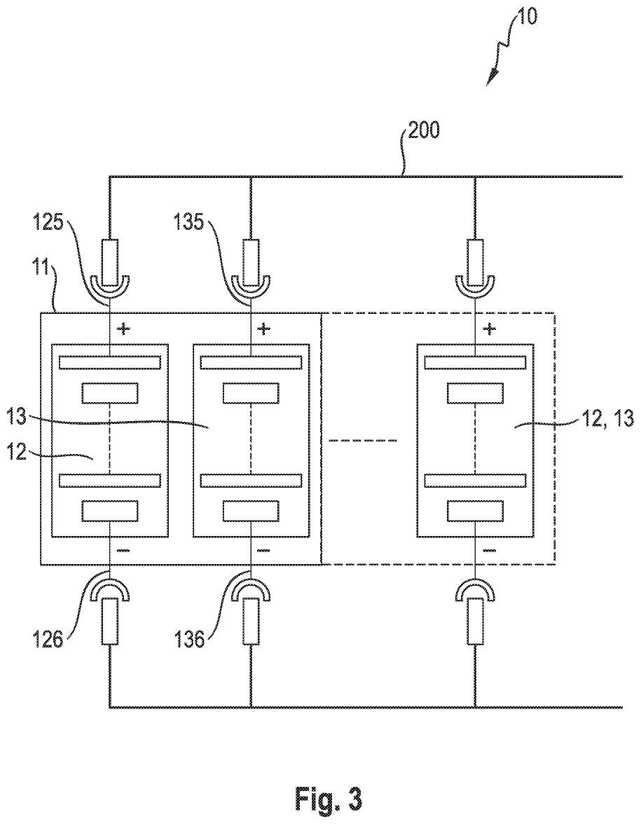

FIG. 3 illustrates a possible connection 200 of the battery blocks 12, 13 of the battery module 10 in the example according to FIG. 2. The battery blocks 12, 13 are connected in parallel via power connection contacts 125, 126, 135, 136. In this example of the battery module, a serial connection is also possible, with which higher voltages can be achieved. In this example, however, the connection technology would be somewhat more complex.

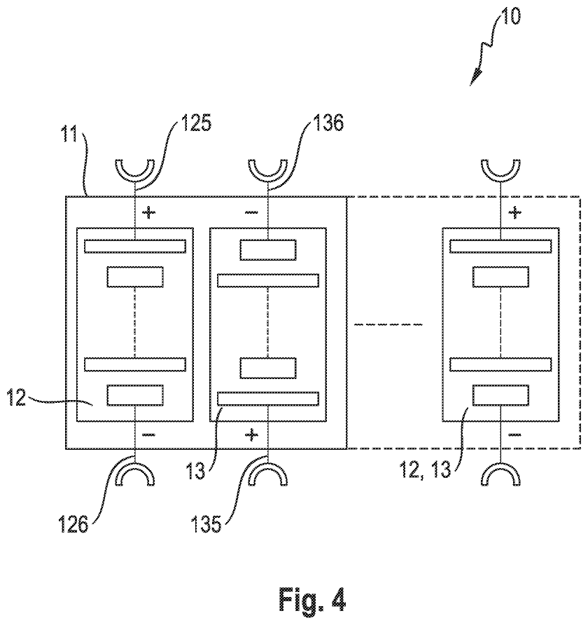

FIG. 4 illustrates another possible example of a battery module 10 with two or possibly more battery blocks 12, 13. In this example, the cell blocks 12 and 13 are of alternate polarity so that on one side of the module housing 11 there is a positive power connection contact 125 of the first battery block 12 and a negative power connection contact 136 of the adjacent battery block 13. Correspondingly, a negative power connection contact 126 of the battery block 12 and a positive power connection contact 135 of the adjacent battery block 13 are also located on the opposite side of the module housing. In an instance of more than two blocks, the positive and negative power connection contacts are arranged on the two sides in alternating sequence. With this example of the battery module, a series circuit or a serial circuit can be implemented particularly easily and practicably.

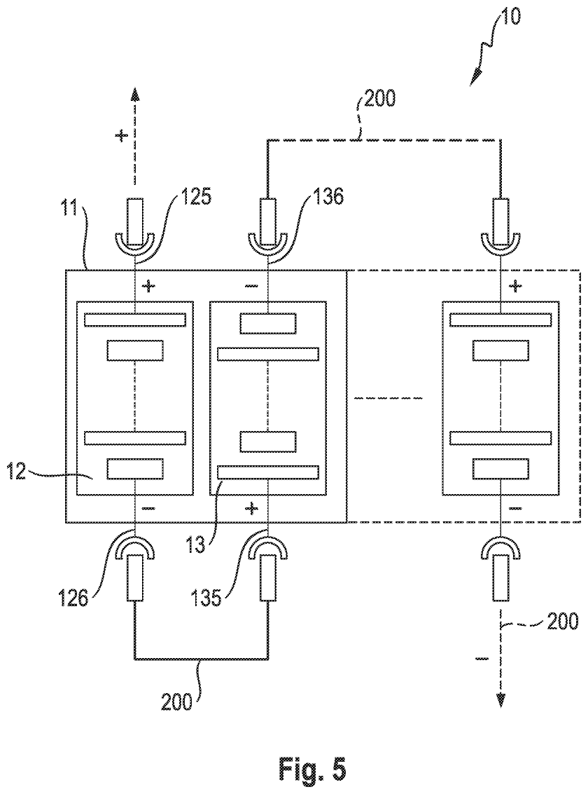

FIG. 5 illustrates a serial connection 200 in the example of the battery module 10 of FIG. 4. For example, common shorting plugs (service plugs) or other internal or external switches or contact blades may be used for the connection 200.

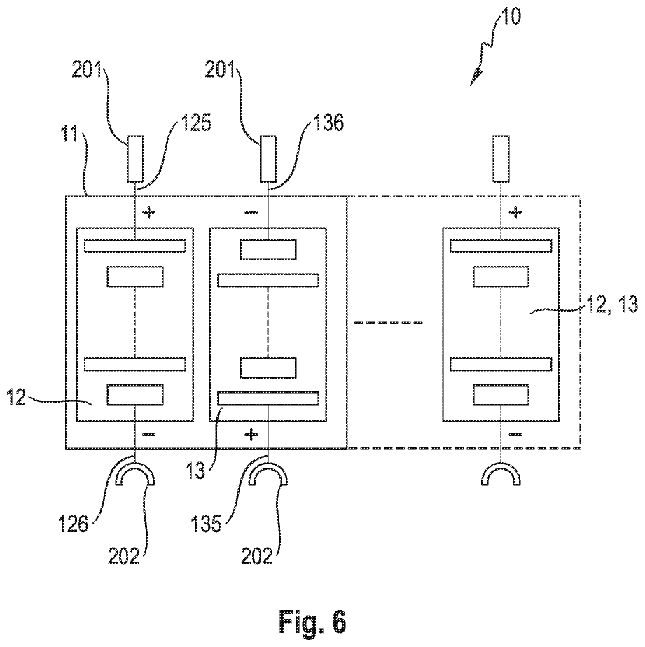

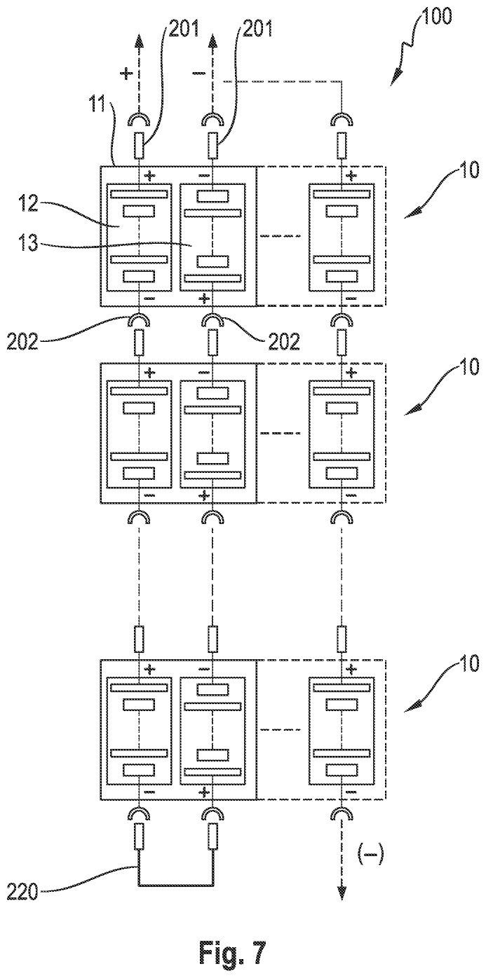

FIG. 6 illustrates a preferred example of a battery module 10 whose battery blocks 12, 13 (similar to the example in FIGS. 4 and 5) are oriented with opposite polarity. In this example, the positive and negative terminal contacts 125 and 136 on one side of the module housing 11 are male plug contacts 201 and the negative and positive power terminal contacts 126 and 135 on the opposite side of the module housing 11 are female contacts 202. If two battery modules of this design are stacked on top of each other, serial connection of battery blocks 12, 13 of the different battery modules is easily possible, as illustrated in FIG. 7.

FIG. 7 illustrates a modular battery system 100, wherein the individual battery modules 10 are stacked on top of each other in the example shown in FIG. 6. For example, the battery system 100 may be constructed with two or more battery modules 10. When the battery modules 10 are stacked, a serial connection of battery blocks 12 and 13 of different battery modules arranged one above the other in the stack is formed. In this example, the female contacts 202 of the module on top in each instance make contact with the plug-in contacts 201 of the battery module arranged below. Of course, the female contacts 202 and the male contacts 201 can also be arranged interchangeably in each instance. In addition, other contacting devices such as contact surfaces and/or contact springs or the like are also possible.

A particular advantage is that each battery module 10 has a plurality of independent, variably connectable cell blocks 12, 13. Thus, the number of battery modules required to achieve a certain stack voltage of the entire modular battery system 100 can be significantly reduced.

For example, the connecting member 220 is suitable for implementing a switch for the final activation of the serial connection. The connecting member 220 can, for example, be designed as an additional switch, plug, relay or the like to close this bridge last so that the serial connection is closed and the high-voltage system 100 is thus finally enabled only after the individual battery modules 10 have been assembled and connected.

In addition to the power connection contacts, further contact options are advantageously provided on the individual battery modules, in particular further connection contacts, not shown in more detail here, for connecting data and/or communication lines and/or one or possibly more safety lines. For this purpose, an additional modular connector or, if necessary, several additional modular connectors can be provided on each battery module 10, via which various further contacts and connections are possible.

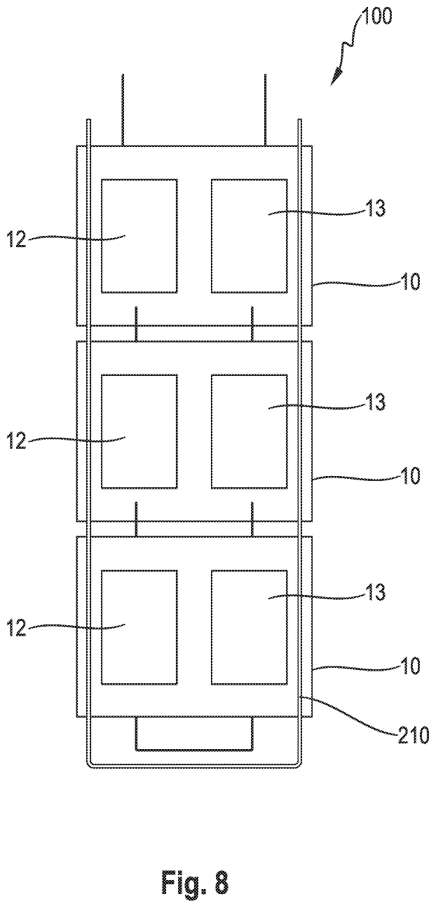

FIG. 8 shows another example of a modular battery system 100, which in this example is constructed of three battery modules 10 each having two battery blocks 12, 13. The three battery modules 10 are stacked on top of each other and the battery blocks 12, 13 of the three battery modules 10 are connected in series. In this manner, a modular battery system with a nominal voltage of over 300 V can be provided with three battery modules each having two battery blocks, each providing no more than a DC voltage of 50 V.

In this example, a safety line 210 is also provided that is looped through all of the battery modules 10, whereby each of the battery blocks 12, 13 can access the safety line 210. Insofar as a fault occurs in one of the battery blocks 12, 13, the safety line 210 can be directly interrupted so that the battery system 100 can be shut down immediately in the event of a fault.

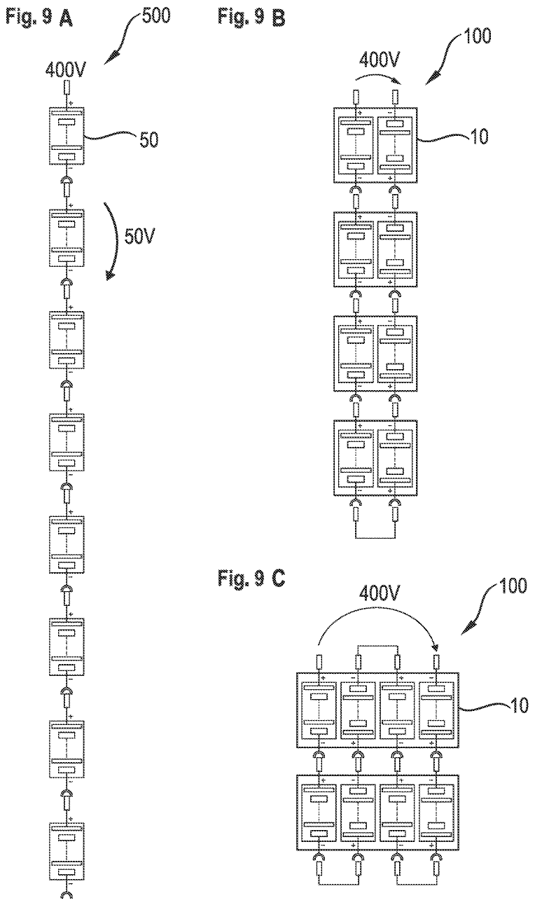

FIGS. 9A, 9B and 9C illustrate the particular advantages of a modular battery system 100, as shown in FIG. 9B or C, over a conventional modular battery system 500, as shown in FIG. 9A. The individual battery modules 10, representing the battery modules, and the conventional battery modules 50 each have voltages that are not dangerous to touch (e.g., 50 volts maximum) and may be referred to as low-voltage battery modules. In this regard, the modular battery systems 100 are constructed with substantially fewer individual battery modules 10 while providing a voltage comparable to that of a conventional modular battery system 500 (for example, 400 volts). For example, a conventional high-voltage modular battery system 500 requires eight individual battery modules 50, each providing, for example, 50 V DC, connected in series. In a modular battery system 100, only four battery modules 10 are required to achieve the same voltage of 400 V in the example shown in FIG. 9B. In this example, each of the battery modules 10 comprises two battery blocks, each of which has an externally tappable voltage of 50 V or less. By connecting the individual battery blocks of the battery modules 10 in series with each other, the total voltage of 400 V is possible while halving the number of modules. In the example of the modular battery system 100 shown in FIG. 9C, only two battery modules 10 are required to achieve the total voltage of 400 V. The battery modules 10 are connected in series. Each of these battery modules 10 comprises four battery blocks, each with an externally tappable voltage of 50 V, which are connected in series as a whole.

Any number of independent cell blocks can be integrated into a battery module. In general, powers of two, for example, two, four or eight, are preferred. However, odd numbers such as three, five or eleven battery blocks per battery module are of course also possible.

In addition to high-voltage applications, low-voltage applications of the battery modules are also possible with which, for example, various voltage standards can be implemented such as 48 V.

1-15. (canceled)

16. A battery module comprising:
a module housing; and
at least two battery blocks arranged within the module housing, wherein
the battery blocks each comprise at least two energy storage elements having at least one positive electrode and at least one negative electrode,
the at least two energy storage elements of one battery block are connected in series and/or in parallel;
each of the battery blocks provides a maximum of 60 volts DC;
the module housing has at least two positive power connection contacts and at least two negative power connection contacts connected to the battery blocks so that the DC voltages supplied by the battery blocks can be tapped from outside the module housing; and
a maximum DC voltage that can be tapped between a positive and a negative power connection contact is 60 volts.

17. The battery module of claim 16, wherein at least one of:
the module housing is prismatic;
the electrical power connection contacts of the module housing are located on at least two sides of the module housing or on opposite sides of the module housing; and
for each battery block, the module housing has a positive and a negative electrical power connection contact, one of which is located on one of the sides and the other on another of the sides of the module housing or on opposite sides of the module housing.

18. The battery module according to claim 16, wherein
the module housing has one side, on which all negative power terminal contacts are located, and another side on which all positive power terminal contacts are located.

19. The battery module according to claim 16, wherein
the module housing has a side on which a part of the negative power terminal contacts and a part of the positive power terminal contacts are disposed, and another side on which all of the other positive power terminal contacts and all of the other negative power terminal contacts are disposed with the positive and negative power terminal contacts disposed on the sides in an alternating sequence.

20. The battery module according to claim 18, wherein
the electrical power connection contacts on one side of the module housing are designed as a male part and the electrical power connection contacts on the other side or on the opposite side of the module housing are designed as a female part of a plug connection.

21. The battery module according to claim 16, wherein
the energy storage elements of a battery block are cylindrical round cells; and
the energy storage elements of a battery block are held by a holder or a holder made of plastic.

22. The battery module according to claim 16, wherein
the module housing has at least one further connection contact for coupling at least one communication line and/or at least one safety line.

23. A modular battery system comprising:
at least two battery modules according to claim 16; and
at least two battery blocks of one of the battery modules and/or at least two battery blocks from different battery modules of the battery system are electrically connected via the positive and negative electrical power connection contacts of their module housings.

24. The modular battery system of claim 23, wherein
the battery modules of the battery system are stacked; and
within the stack, sides of the module housings of adjacent battery modules on which negative and/or positive power connection contacts are arranged face each other.

25. The modular battery system of claim 24, wherein
within the stack, the power terminal contacts of adjacent battery modules are in direct contact with each other or the power terminal contacts are directly or indirectly connected to each other.

26. The modular battery system of claim 24, wherein
the battery modules each have a first side on which all negative power terminal contacts are disposed and a second side on which all positive power terminal contacts are disposed,
within the stack, the battery modules are arranged such that, in adjacent battery modules, the first side of one of the adjacent battery modules faces the second side of the other of the adjacent battery modules, and
at least a part of the battery blocks of the respective battery modules are connected in parallel with one another.

27. The modular battery system of claim 24, wherein
the battery modules each have a first side on which a part of the negative power terminal contacts and a part of the positive power terminal contacts are disposed, and a second side on which all other positive power terminal contacts and all other negative power terminal contacts are disposed,
within the stack, the battery modules are arranged such that in adjacent battery modules, the first side of one of the adjacent battery modules faces the second side of the other of the adjacent battery modules, and
the battery blocks of the respective battery modules are at least partially connected in series with battery blocks of a respective adjacent battery module and/or with battery blocks of the same battery module.

28. The modular battery system of claim 23, further comprising:
at least one switch that activates and/or deactivates the connection of the battery blocks of the battery modules forming the battery system.

29. A method of assembling a battery system comprising:
providing at least two battery modules according to claim 16;
assembling the battery modules to form a battery system; and
electrically connecting the battery blocks of individual battery modules to each other.

30. The method of claim 29, further comprising:
conducting a final activation of the connection of the battery blocks by actuating a switch of the battery system.
